(19) United States
(12) Patent Application Publication
(10) Pub. No.: US 2022/0372669 A1
(43) Pub. Date: Nov. 24, 2022

(54) CORE-SHEATH COMPOSITE FIBER FOR ARTIFICIAL HAIR, HEADWEAR PRODUCT INCLUDING SAME, AND PRODUCTION METHOD FOR SAME

(71) Applicant: KANEKA CORPORATION, Osaka (JP)

(72) Inventor: Takashi Ogino, Osaka (JP)

(73) Assignee: KANEKA CORPORATION, Osaka (JP)

(21) Appl. No.: 17/881,897

(22) Filed: Aug. 5, 2022

Related U.S. Application Data
(63) Continuation of application No. PCT/JP2021/000050, filed on Jan. 5, 2021.

(30) Foreign Application Priority Data
Mar. 3, 2020 (JP) 2020-036163

(51) Int. Cl. D01F 8/14; D01F 8/12; B29C 48/00; B29C 48/21; D01D 5/34; D01D 5/08; D01D 5/253; A41G 3/00; A41G 5/00

(52) U.S. Cl. CPC D01F 8/14; D01F 8/12; B29C 48/022; B29C 48/21; D01D 5/34; D01D 5/08; D01D 5/253; A41G 3/00; A41G 5/004; B29K 2067/003

(57) ABSTRACT

A core-sheath conjugate fiber for artificial hair including a core part and a sheath part is provide. The core part includes a polyester-based resin composition that contains a polyester-based resin and the sheath part is comprised of a polyamide-based resin composition that contains a polyamide-based resin. The core-sheath conjugate fiber for artificial hair has a single fiber fineness of 20 dtex or more and 80 dtex or less and a coefficient of variation of the single fiber diameter of 10% or more and 40% or less. With this configuration, a core-sheath conjugate fiber for artificial hair that has a touch close to that of human hair and a good gloss, a hair ornament product including the same, and a method for producing the same are provided.

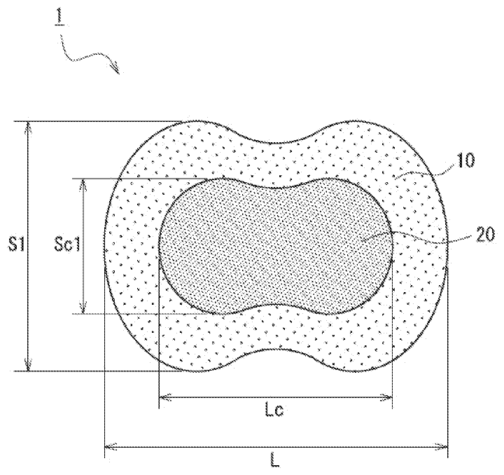

### TECHNICAL FIELD

One or more embodiments of the present invention relate to a core-sheath conjugate fiber for artificial hair capable of being used as an alternative to human hair, a hair ornament product including the same, and a production method therefor.

### BACKGROUND

Conventionally, human hair is used for hair ornament products such as hairpieces, hair wigs, hair extensions, hair bands, and doll hair. However, in recent years, it is becoming difficult to obtain human hair, and thus there is an increasing demand for artificial hair capable of being used as an alternative to human hair. Examples of synthetic fibers that can be used for artificial hair include acrylic-based fibers, vinyl chloride-based fibers, vinylidene chloride-based fibers, polyester-based fibers, polyamide-based fibers, and polyolefin-based fibers. Artificial hair is required to have a touch and appearance close to those of human hair.

As a technology for making the appearance of a fiber for artificial hair close to the appearance of natural hair, a technology of combining fibers for artificial hair having various degrees of fineness to obtain a random fineness configuration like that of natural hair has been proposed to realize an appearance like that of human hair as described in Patent Document 1.

As a technology for making the touch of a fiber for artificial hair close to the touch of human hair, a conjugate spinning technology has been proposed as described in Patent Document 2. In this technology, a polyester-based fiber having a high rigidity is used for a core part, and the periphery of the core part is covered with a polyamide-based component that makes it possible to obtain a touch very close to that of human hair, and thus the touch is improved.

### Patent Document

Patent Document 1: JP2010-121219A

Patent Document 2: WO2017/187843

However, in the technology described in Patent Document 1, the number of processing steps increases because a plurality of fibers having different degrees of fineness need to be combined in post-processing. Also, the technology described in Patent Document 1 exclusively addresses problems regarding texture, and cannot address problems regarding touch. On the other hand, the fiber described in Patent Document 2 has a good touch, but the fiber has a glittering gloss that is peculiar to synthetic fibers and far from that of human hair.

In order to address the above, one or more embodiments of the present invention provide a core-sheath conjugate fiber for artificial hair that has a touch close to that of human hair and also has a good gloss, a hair ornament product including the same, and a method for producing the same.

### SUMMARY

One or more embodiments of the present invention relate to a core-sheath conjugate fiber for artificial hair including a core part and a sheath part, wherein the core part is comprised of a polyester-based resin composition that contains a polyester-based resin, the sheath part is comprised of a polyamide-based resin composition that contains a polyamide-based resin, and the core-sheath conjugate fiber for artificial hair has a single fiber fineness of 20 dtex or more and 80 dtex or less and a coefficient of variation of the single fiber diameter of 10% or more and 40% or less.

Furthermore, one or more embodiments of the present invention relate to a hair ornament product including the core-sheath conjugate fiber for artificial hair

Furthermore, one or more embodiments of the present invention relate to a method for producing the core-sheath conjugate fiber for artificial hair, including a step of melt spinning the polyester-based resin composition and the polyamide-based resin composition using a core-sheath conjugate nozzle, wherein the polyamide-based resin composition has a melt viscosity in the range of 200 Pa·s or more and 250 Pa·s or less at a set temperature of the core-sheath conjugate nozzle.

According to one or more embodiments of the present invention, it is possible to provide a core-sheath conjugate fiber for artificial hair and a hair ornament product having a touch dose to that of human hair and also a natural doss like that of human hair.

According to the production method of one or more embodiments of the present invention, it is possible to obtain a core-sheath conjugate fiber for artificial hair having a touch close to that of human hair and a natural gloss like that of human hair.

### BRIEF DESCRIPTION OF THE DRAWINGS

The FIGURE is a schematic view showing a fiber cross section of a core-sheath conjugate fiber for artificial hair according to an example of one or more embodiments of the present invention.

### DETAILED DESCRIPTION

The inventor of one or more embodiments of the present invention conducted an in-depth research in order to address the above. As a result, it was found that, in a core-sheath conjugate fiber for artificial hair including a core part and a sheath part, if the core part is comprised of a polyester-based resin composition that contains a polyester-based resin, the sheath part is comprised of a polyamide-based resin composition that contains a polyamide-based resin, and the single fiber fineness and a coefficient of variation of the single fiber diameter are within predetermined ranges, it is possible to suppress the gloss peculiar to synthetic fibers and to obtain a fiber for artificial hair that has a natural gloss like that of human hair and a touch like that of human hair, and thus one or more embodiments of the present invention were achieved.

### Shape of Core-Sheath Conjugate Fiber

The core-sheath conjugate fiber for artificial hair has a single fiber fineness of 20 dtex or more and 80 dtex or less. With this configuration, it is possible to obtain a fiber for artificial hair having a touch and a gloss close to those of human hair. The single fiber fineness of the core-sheath conjugate fiber for artificial hair may be 30 dtex or more and 70 dtex or less, or 40 dtex or more and 60 dtex or less. The single fiber fineness of the core-sheath conjugate fiber for artificial hair can be determined by measuring the fineness of 10 samples (single fiber samples) using a fineness measuring apparatus and calculating an average of the measured values, for example.

The core-sheath conjugate fiber for artificial hair has a coefficient of variation (CV value) of the single fiber diameter of 10% or more and 40% or less. If the CV value of the single fiber diameter is less than 10%, undulations on the fiber surface are small and the fiber has a smooth surface. Therefore, incident light is not sufficiently scattered and the fiber has a glittering gloss peculiar to synthetic fibers, and also the touch becomes flat. On the other hand, if the CV value of the single fiber diameter is more than 40%, undulations on the fiber surface are large, and therefore, the glittering gloss is suppressed, but the touch is significantly impaired. The coefficient of variation (CV value) of the single fiber diameter of the core-sheath conjugate fiber for artificial hair is calculated using the expression (1) below based on a total of 100 pieces of fiber diameter data obtained by using randomly selected 10 samples of single fiber and measuring the fiber diameter at 10 points set at intervals of 10 cm in the length direction of each fiber using a fineness measuring apparatus, for example.

Coefficient of variation (%)=(standard deviation/average value)×100 (1)

The cross sectional shape of the core-sheath conjugate fiber for artificial hair is not particularly limited, and may be a circular shape or any other shape. Examples of other shapes include an elliptical shape and a multilobed shape such as a flat two-lobed shape. The cross sectional shape of the core-sheath conjugate fiber for artificial hair may be the same as or differ from the cross sectional shape of the core part. From the viewpoint of the touch, gloss, combing property, and the like, the core part may have a modified flat two-lobed cross sectional shape or a modified elliptical cross sectional shape including a pair of protrusions protruding from the center side toward the outer circumferential side along a minor axis direction of a fiber cross section.

In a flat two-lobed shape, two lobal portions having a shape selected from the group consisting of a circular shape and an elliptical shape are connected via recessed portions. The circular or elliptical shape does not absolutely have to be a continuous arc, and may also be a substantially circular shape or a substantially elliptical shape that is partially deformed, as long as no acute angle is formed.

The FIGURE is a schematic view showing a fiber cross section of a core-sheath conjugate fiber for artificial hair according to an example of one or more embodiments of the present invention. The core-sheath conjugate fiber 1 for artificial hair is comprised of a sheath part 10 and a core part 20, and the fiber 1 and the core part 20 both have cross sections having flat two-lobed shapes in which two elliptical portions are connected via recessed portions.

It is preferable that, in the flat two-lobed fiber cross section of the core-sheath conjugate fiber for artificial hair, a length (represented by “L”) of a major axis of the fiber cross section, which is a straight line with the largest length among an axisymmetric axis and straight lines connecting any two points on the outer circumference of the fiber cross section so as to be in parallel to the axisymmetric axis, and a length (represented by “S1”) of a minor axis of the fiber cross section, which is a straight line connecting two points so as to have the largest length when connecting any two points on the outer circumference of the fiber cross section so as to be perpendicular to the major axis of the fiber cross section, satisfy the equation (2) below.

L/S1=1.1 or more and 2.0 or less (2)

Furthermore, it is preferable that, in the flat two-lobed fiber cross section, a length (represented by “Lc”) of a major axis of the core part cross section, which is a straight line with the largest length among an axisymmetric axis and straight lines connecting any two points on the outer circumference of the core part cross section so as to be in parallel to the axisymmetric axis, and a length (represented by “Sc1”) of a minor axis of the core part cross section, which is a straight line connecting two points so as to have the largest length when connecting any two points on the outer circumference of the core part cross section so as to be perpendicular to the major axis of the core part cross section, satisfy the equation (3) below.

Lc/Sc1=1.3 or more and 2.0 or less (3)

A modified flat two-lobed shape is obtained by modifying the flat two-lobed shape so as to include a pair of protrusions protruding from the center side toward the outer circumferential side along the minor axis direction of the fiber cross section. In the flat two-lobed shape, two lobal portions having a shape selected from the group consisting of a circular shape and an elliptical shape are connected via recessed portions, whereas in the modified flat two-lobed shape, the two lobal portions having a shape selected from the group consisting of a circular shape and an elliptical shape are connected via the protrusions.

The above-described cross-sectional shapes of the fiber and the core part and the core-to-sheath area ratio can be controlled by using a nozzle (pores) with a shape close to the target cross sectional shape.

The core-sheath conjugate fiber for artificial hair may have a core-to-sheath area ratio in the range of core:sheath=2:8 to 8:2. If the core-to-sheath area ratio is outside this range and the ratio of either component is low, the component with the lower ratio is unlikely to be discharged stably and large asperities are likely to be formed. Accordingly, the coefficient of variation of the single fiber diameter is likely to be large and there is a risk that the gloss will be impaired. Moreover if the core-to-sheath area ratio is in the above range, the value of bending rigidity; which is a physical property relating to the touch, texture, and the like, is close to that of human hair, and thus artificial hair with a quality similar to that of human hair is likely to be obtained. If the ratio of the core part is lower than this range, the bending rigidity value tends to he smaller than that of human hair, and thus artificial hair with a quality similar to that of human hair is unlikely to be obtained. Also, an extremely thin portion or a discontinuous portion is likely to be formed in the core part, and there is a risk that a crack or a split will be generated from that portion. On the other hand, if the ratio of the core part is higher than this range, the bending rigidity value becomes too large and the quality is not close to that of human hair, and, moreover, the sheath part is so thin that the core part is likely to be exposed, which is not preferable. From the viewpoint of obtaining a touch, texture, and the like dose to those of human hair, the core-to-sheath area ratio of the core-sheath conjugate fiber for artificial hair may be in the range of core:sheath=3:7 to 7:3.

All of the core-sheath conjugate fibers for artificial hair do not necessarily have to have the same fineness and the same cross-sectional shape, and fibers having different values of fineness and different cross-sectional shapes may be mixed. In order to prevent the core part and the sheath part from separating from each other, it is preferable that, in the fiber cross section of the core-sheath conjugate fiber for artificial hair, the core part is completely covered by the sheath part without being exposed to the fiber surface.

### Composition of Core-Sheath Conjugate Fiber

In the core-sheath conjugate fiber for artificial hair, the core part is comprised of a polyester-based resin composition that contains a polyester-based resin, i.e., a polyester-based resin composition containing a polyester-based resin as a main component, and the sheath part is comprised of a polyamide-based resin composition that contains a polyamide-based resin, i.e., a polyamide-based resin composition containing a polyamide-based resin as a main component.

When the total weight of the polyamide-based resin composition containing a polyamide-based resin as a main component is taken as 100% by weight, the polyamide-based resin composition contains the polyamide-based resin in an amount of more than 50% by weight, preferably 70% by weight or more, even more preferably 80% by weight or more, even more preferably 90% by weight or more, and even more preferably 95% by weight or more.

When the total weight of the polyester-based resin composition containing a polyester-based resin as a main component is taken as 100% by weight, the polyester-based resin composition contains the polyester-based resin in an amount of more than 50% by weight, preferably 70% by weight or more, even more preferably 80% by weight or more, even more preferably 90% by weight or more, and even more preferably 95% by weight or more.

Furthermore, from the viewpoint of flame retardance, a flame retardant may also be used, and a polyester-based resin composition containing a polyester-based resin and a bromine-based polymer flame retardant, a polyamide-based resin composition containing a polyamide-based resin and a bromine-based polymer flame retardant, and the like may be used. From the viewpoint of heat resistance and flame retardance, it is preferable that the core part of the core-sheath conjugate fiber for artificial hair is comprised of a polyester-based resin composition containing a polyester-based resin and a bromine-based polymer flame retardant, and the sheath part thereof is comprised of a polyamide-based resin composition containing a polyamide-based resin and a bromine-based polymer flame retardant. It is more preferable that the core part is comprised of a polyester-based resin composition that contains 100 parts by weight of one or more of polyester-based resins selected from the group consisting of polyalkylene terephthalate and a copolymerized polyester mainly containing polyalkylene terephthalate and 5 parts by weight or more and 40 parts by weight or less of a bromine-based polymer flame retardant, and the sheath part is comprised of a polyamide-based resin composition that contains 100 parts by weight of a polyamide-based resin mainly containing at least one selected from the group consisting of Nylon 6 and Nylon 66 and 5 parts by weight or more and 40 parts by weight or less of a bromine-based polymer flame retardant.

Polyalkylene terephthalate is not particularly limited, and may be, for example, polyethylene terephthalate, polypropylene terephthalate, polybutylene terephthalate, or polycyclohexane dimethylene terephthalate. The copolymerized polyester mainly containing polyalkylene terephthalate is not particularly limited, and may be, for example, a copolymerized polyester mainly containing polyalkylene terephthalate such as polyethylene terephthalate, polypropylene terephthalate, polybutylene terephthalate, or polycyclohexane dimethylene terephthalate, and further containing other copolymerizable components. The “copolymerized polyester mainly containing polyalkylene terephthalate” refers to a copolymerized polyester containing polyalkylene terephthalate in an amount of 80 mol % or more.

Examples of the other copolymerizable components include: polycarboxylic acids such as isophthalic acid, orthophthalic acid, naphthalenedicarboxylic acid, paraphenylenedicarboxylic acid, trimellitic acid, pyromellitic acid, succinic acid, glutaric acid, adipic acid, suberic acid, azelaic acid, sebacic acid, and dodecanedioic acid, and their derivatives; dicarboxylic acids and their derivatives containing sulfonates such as 5-sodiumsulfoisophthalic acid and dihydroxyethyl 5-sodiumsulfolsoplithalate; 1,2-propanediol; 1,3-propanediol; 1,4-butanediol; 1,6-hexanediol; neopentyl glycol; 1,4-cyclohexanedimethanol; diethylene glycol; polyethylene glycol; trimethylolpropane; pentaerythritol; 4-hydroxybenzoic acid; ε-caprolactone; and an ethylene glycol ether of bisphenol A.

The copolymerized polyester may be produced by adding a small amount of other copolymerizable components to polyalkylene terephthalate serving as a main component, and allowing them to react with each other, from the viewpoint of stability and ease of operation. Examples of the polyalkylene terephthalate include a polymer of terephthalic acid and/or its derivatives (e.g., methyl terephthalate) and alkylene glycol. The copolymerized polyester may be produced by adding a small amount of monomer or oligomer component serving as other copolymerizable components, to a mixture of terephthalic acid and/or its derivatives (e.g., methyl terephthalate) and alkylene used for polymerization of polyalkylene terephthalate serving as a main component, and subjecting them to polymerization.

It is sufficient that the copolymerized polyester has a structure in which the other copolymerizable components are polycondensed on the main chain and/or side chain of polyalkylene terephthalate serving as a main component, and the copolymerization method and the like are not particularly limited.

Specific examples of the copolymerized polyester mainly containing polyalkylene terephthalate include a polyester obtained through copolymerization of polyethylene terephthalate serving as a main component with one compound selected from the group consisting of an ethylene glycol ether of bisphenol A, 1,4-cyclohexanedimethanol, isophthalic acid, and dihydroxyethyl 5-sodiumsulfoisophthalate.

Polyalkylene terephthalate and the copolymerized polyester mainly containing polyalkylene terephthalate may be used alone or in a combination of two or more. In particular, polyethylene terephthalate; polypropylene terephthalate; polybutylene terephthalate; a polyester obtained through copolymerization of polyethylene terephthalate serving as a main component with an ethylene glycol ether of bisphenol A; a polyester obtained through copblymerization of polyethylene terephthalate serving as a main component with 1,4-cydohexanedimethanol; a polyester obtained through copolymerization of polyethylene terephthalate serving as a main component with isophthalic acid; a polyester obtained through copolymerization of polyethylene terephthalate serving as a main component with dihydroxyethyl 5-sodiumsulfoisophthalate, and the like may be used alone or in a combination of two or more.

The melt viscosity of the polyester-based resin composition may be in the range of 250 Pa·s or more and 350 Pa·s or less at a set temperature of the nozzle, or 280 Pa·s or more and 320 Pa·s or less. If the melt viscosity is 250 Pa·s or more, the mechanical strength of the obtained fiber does not decrease, and there is no risk of dripping during a combustion test. If the melt viscosity is 350 Pa·s or less, the molecular weight is not too large, and it is easy to perform melt spinning.

The bromine-based polymer flame retardant is not particularly limited, but it is preferable to use a brominated epoxy-based flame retardant, for example, from the viewpoint of heat resistance and flame retardance. A brominated epoxy-based flame retardant having an epoxy group or tribromophenol at a molecular end thereof may be used as a raw material. The structure of the brominated epoxy-based flame retardant after melt kneading is not particularly limited, but it is preferable that 80 mol % or more of the structure is comprised of a constituent unit represented by the formula (1) below when the total number of constituent units each represented by the formula (1) below and constituent units obtained by at least partially modifying the formula (1) below is taken as 100 mol %. The structure of the brominated epoxy-based flame retardant may change at a molecular end thereof after melt kneading. For example, a molecular end of the brominated epoxy-based flame retardant may be substituted by a hydroxyl group, a phosphate group, a phosphoric acid group, or the like other than an epoxy group or tribromophenol, or may be bound to a polyester component through an ester group.

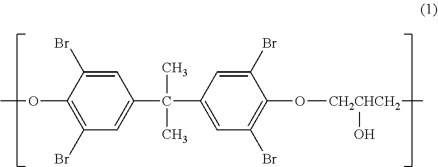

Furthermore, part of the structure of the brominated epoxy-based flame retardant, other than the molecular end, may be changed. For example, the brominated epoxy- based flame retardant may have a branched structure in which the secondary hydroxyl group and the epoxy group are bound. Also, part of the bromine of the formula (1) may be eliminated or added, as long as the bromine content in the molecules of the brominated epoxy-based flame retardant does not change significantly.

For example, a polymeric brominated epoxy-based flame retardant as represented by the formula (2) below may be used as the brominated epoxy-based flame retardant. In the formula (2) below, m is 1 to 1000. Examples of the polymeric brominated epoxy-based flame retardant represented by the formula (2) below include a commercially available product such as a brominated epoxy-based flame retardant (product name “SR-T2MP”) manufactured by Sakamoto Yakuhin Kogyo Co., Ltd.

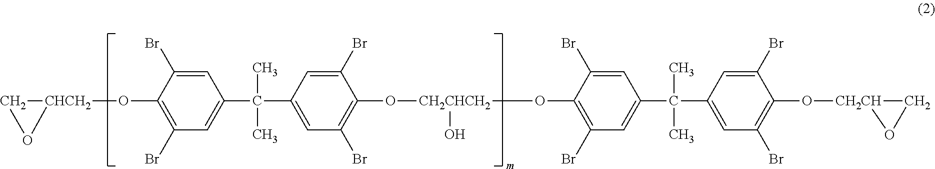

The polyamide-based resin means a nylon resin obtained through polymerization of one or more selected from the group consisting of lactam, aminocarboxylic acid, a mixture of dicarboxylic acid and diamine, a mixture of a dicarboxylic acid derivative and diamine, and a salt of dicarboxylic acid and diamine.

Specific examples of the lactam include, but are not particularly limited to, for example, 2-azetidinone, 2-pyrrolidinone, 6-valerolactam, ε-caprolactam, enantholactam, capryllactam, undecalactam, and laurolactam. Of these lactams, it is preferable to use ε-caprolactam, undecalactain, and laurolactam, and more preferable to use ε-caprolactam. These lactams may be used alone or in a combination of two or more.

Specific examples of the aminocarboxylic acid include, but are not particularly limited to, for example, 6-aminocaproic acid, 7-aminoheptanoic acid, 8-aminooctanoic acid, 9-aminononanoic acid, 10-aminodecanoic acid, 11-aminoundecanoic acid, and 12-aminododecanoic acid. Of these aminocarboxylic acids, it is preferable to use 6-aminocaproic acid, 11-aminoundecanoic acid, and 12-aminododecanoic acid, and more preferable to use 6-aminocaproic acid. These aminocarboxylic acids may be used alone or in a combination of two or more.

Specific examples of the dicarboxylic acid that can be used for the mixture of dicarboxylic acid and diamine, the mixture of a dicarboxylic acid derivative and diamine, or the salt of dicarboxylic acid and diamine include, but are not particularly limited to, for example: aliphatic &carboxylic acids such as oxalic acid, malonic acid, succinic acid, glutaric acid, adipic acid, pimelic acid, suberic acid, azelaic acid, sebacic acid, undecanedioic acid, dodecanedioic acid, brasylic acid, tetradecanedioic acid, pentadecanedioic acid, and octadecanedioic acid; alicyclic dicarboxylic acids such as cyclohexane dicarboxylic acid; and aromatic dicarboxylic acids such as phthalic acid, isophthalic acid, terephthalic acid, and naphthalenedicarboxylic acid. Of these dicarboxylic acids, it is preferable to use adipic acid, sebacic acid, dodecanedioic acid, terephthalic acid, and isophthalic acid, and more preferable to use adipic acid, terephthalic acid, and isophthalic acid. These dicarboxylic acids may be used alone or in a combination of two or more.

Specific examples of the diamine that can be used for the mixture of dicarboxylic acid and diamine, the mixture of a dicarboxylic acid derivative and (hairline, or the salt of dicarboxylic acid and diamine include, but are not particularly limited to, for example: aliphatic diamines such as 1,4-diaminobutane, 1,5-diaminopentane, 1,6-diaminohexane, 2-methyl-1,5-diaminopentane (MDP), 1,7-diaminoheptane, 1,8-diaminooctane, 1,9-diaminononan, 1,10-diaminodecane, 1,11-diaminoundecane, 1,12-diaminododecane, 1,13-diaminotridecane, 1,14-diaminotetradecane, 1,15-diaminopentadecane, 1,16-diaminohexadecane, 1,17-diaminoheptadecane, 1,18-diaminooctadecane, 1,19-diaminononadecane, and 1,20-diaminoeicosane; alicyclic diamines such as cyclohexanediamine and bis-(4-aminohexyl)methane; and aromatic diamines such as m-xylylenediamine and p-xylylenediamine. Of these diamines, it is preferable to use an aliphatic diamine, and more preferable to use hexamethylenediamine. These diamines may be used alone or in a combination of two or more.

The polyamide-based resin (alternatively referred to as a “nylon resin”) is not particularly limited, but it is preferable to use, for example, Nylon 6, Nylon 66, Nylon 11, Nylon 12,- Nylon 6/10, Nylon 6/12, semi-aromatic nylon containing the Nylon 6T and/or 6I unit, copolymers of these nylon resins, or the like. It is more preferable to use Nylon 6, Nylon 66, or a copolymer of Nylon 6 and Nylon 66.

The polyamide-based resin can be produced for example, using a polyamide-based resin polymerization method in which a raw material for the polyamide-based resin is heated in the presence or absence of a catalyst. During the polymerization, stirring may or may not be performed, but it is preferable to perform stirring in order to obtain a uniform product. The polymerization temperature can be set as appropriate according to the degree of polymerization, the reaction yield, and the reaction time of a target polymer, but it is preferable to set the temperature to a low temperature in consideration of the quality of a finally obtained polyamide-based resin. The reaction ratio can also be set as appropriate. The pressure is not limited, but it is preferable to reduce the pressure in the system in order to efficiently let volatile components move to the outside of the system.

The polyamide-based resin may have a terminal end that is capped by a carboxylic acid compound or an amine compound used as an end-capping agent as xylylene diamine necessary. The concentration of terminal amino groups or terminal carboxyl groups in a nylon resin obtained when a terminal end is capped by adding monocarboxylic acid and/or monoamine is lower than that when such an end-capping agent is not used. On the other hand, the total concentration of terminal amino groups and terminal carboxyl groups does not change when a terminal end is capped by dicarboxylic acid or diamine, but the concentration ratio between terminal amino groups and terminal carboxyl groups changes

Specific examples of the carboxylic acid compound include, but are not particularly limited to, for example; aliphatic monocarboxylic acids such as acetic acid, propionic acid, butyric acid, valeric acid, caproic acid, enanthic acid, caprylic acid, pelargonic acid, undecanoic acid, lamic acid, tridecanoic acid, myristic acid, myristoleic acid, palmitic acid, stearic acid, oleic acid, linoleic acid, and arachic acid; alicyclic monocarboxylic acids such as cyclohexanecarboxylic acid and methylcydohexanecarboxylic acid; aromatic monocarboxylic acids such as benzoic acid, toluic acid, ethylbenzoic acid, and phenylacetic acid; aliphatic dicarboxylic acids such as oxalic acid, malonic acid, succinic acid, glutaric acid, adipic acid, pimelic acid, suberic acid, azelaic acid, sebacic acid, undecaneclioic acid, dodecanedioic acid, brasylic acid, tetradecanedioic acid, pentadecanedioic acid, and octadecanedioic acid; alicyclic dicarboxylic acids such as cydoltexanedicarboxylic acid; and aromatic dicarboxylic acids such as phthalic acid, isophthalic acid, terephthalic acid, and naphthalenedicarboxylic acid.

Specific examples of the amine compound include, but are not particularly limited to, for example: aliphatic monoamines such as butylamine, pentylamine, hexylamine, heptylamine, octylamine, 2-ethylhexylamine, nonylamine, decylamine, undecylamine, dodecylamine, tridecylamine, tetradecylamine, pentadecylamine, hexadecylamine, octadecylamine, nonadecylamine, and icosylamine; alicyclic monoamines such as cyclohexylamine and methylcyclohexylamine; aromatic monoamines such as benzylamine and —-phenylethylamine; aliphatic diamines such as 1,4-diaminobutane, 1,5-diaminopentane, 1,6-diaminohexane, 1,7-diaminoheptane, 1,8-diaminooctane, 1,9-diaminononan, 1,10- diaminodecane, 1,11- diaminoundecane, 1,12 -diaminododecane, 1,13-diaminotridecane, 1,14-diaminotetradecane, 1,15-diaminopentadecane, 1,16-diaminohexadecane, 1,17-diaminoheptadecane, 1,18-diaminooctadecane, 1,19-diaminononadecane, and 1,20-diaminoeicosane; alicyclic diamines such as cyclohexanediamine and bis-(4-aminohexyl)methane; and aromatic diamines such as xylylenediamine.

The terminal group concentration of the polyimide-based resin is not particularly limited, but the terminal amino group concentration may be high, for example, when it is necessary to increase the dyeability for fiber uses or when designing a material suitable for alloying for resin uses. On the other hand, the terminal amino group concentration may be low, for example, when it is required to suppress coloring or gelation under extended aging conditions. Furthermore, the terminal carboxyl group concentration and the terminal amino group concentration may be both low when it is required to suppress reproduction of lactam during re-melting, yarn breakage during melt spinning due to production of oligomer, mold deposit during continuous injection molding, and generation of die marks during continuous extrusion of a film. It is preferable to adjust the terminal group concentration according to the applications, but the terminal amino group concentration and the terminal carboxyl group concentration both may be 1.0×10⁻⁵ to 15.0×10⁻⁵ eq/g, 2.0×10⁻⁵ to 12.0×10⁻⁵ eq/g, or 3.0×10⁻⁵ to 11.0×10⁻⁵ eq/g.

Furthermore, the end-capping agent may be added using a method in which the end-capping agent is added simultaneously with raw materials such as caprolactam at the initial stage of polymerization, a method in which the end-capping agent is added during polymerization, a method in which the end-capping agent is added when a nylon resin in a molten state is caused to pass through a vertical stirring thin-film evaporator, or the like. The end-capping agent may be added without any treatment, or in the form of being dissolved in a small amount of solvent.

The melt viscosity of the polyamide-based resin composition may be in the range of 200 Pa·s or more and 250 Pa·s or less at the set temperature of the nozzle. If the melt viscosity is in the above range, the fiber surface is appropriately leveled, i.e., undulations formed on the resin surface are appropriately smoothed during a period from when the resin composition is discharged from the nozzle to when the resin composition is cooled and solidified. Accordingly, the coefficient of variation of the single fiber diameter falls in an appropriate range, and a fiber having a good gloss and a good touch is likely to be obtained with the mechanical strength of the obtained fiber maintained. If the melt viscosity of the polyamide-based resin composition is higher than 250 Pa·s, the fiber surface is unlikely to be leveled after the resin composition is discharged from the nozzle. Accordingly, the resin composition is cooled and solidified with undulations on the fiber surface remaining large, the coefficient of variation of the single fiber diameter tends to be large, and the touch tends to be impaired. If the melt viscosity of the polyamide-based resin composition is lower than 200 Pa·s, after the resin composition is discharged from the nozzle, the fiber surface is excessively leveled before being cooled and solidified. Accordingly, the fiber has a flat surface with no undulations, the coefficient of variation of the single fiber diameter tends to be small, and there is a risk that both gloss and touch will be impaired.

The melt viscosity of the polyester-based resin composition or the polyamide- based resin composition is measured using the resin composition m the form of pellets dehumidified and dried to have a moisture content of 1000 ppm or less, under conditions of a resin composition sample amount of 20 g, a piston speed of 200 min/min, a capillary length of 20 mm, and a capillary diameter of 1 mm, while setting the temperature to the nozzle temperature during spinning. For example, a capillary rheometer LCR7000 manufactured by Dynisco is used as the measurement apparatus.

From the viewpoint of obtaining a touch and appearance closer to those of human hair and further improving the curling properties and curl retention properties, it is preferable that the core part of the core-sheath conjugate fiber for artificial hair is comprised of a polyester-based resin composition containing one or more of polyester-based resins selected from the group consisting of polyalkylene terephthalate and a copolymerized polyester mainly containing polyalkylene terephthalate, and it is more preferable that the sheath part of the core-sheath conjugate fiber for artificial hair is comprised of a polyamide-based resin composition containing a polyamide-based resin mainly containing at least one selected from the group consisting of Nylon 6 and Nylon 66. The “polyamide-based resin mainly containing at least one selected from the group consisting of Nylon 6 and Nylon 66” means a polyamide-based resin that contains Nylon 6 and/or Nylon 66 in an amount of 80 mol % or more.

As necessary, the core-sheath conjugate fiber for artificial hair may contain various types of additives such as a flame retardant other than the brominated epoxy- based flame retardant, a flame retardant auxiliary, a heat-resistant agent, a stabilizer, a fluorescer, an antioxidant, an antistatic agent, and a pigment within a range that does not inhibit the effects of one or more embodiments of the present invention.

Examples of the flame retardant other than the brominated epoxy-based flame retardant include a phosphorus-containing flame retardant and a bromine-containing flame retardant. Examples of the phosphorus-containing flame retardant include a phosphoric acid ester amide compound and an organic cyclic phosphorus-based compound. Examples of the bromine-containing flame retardant include: bromine-containing phosphoric acid esters such as pentabromotoluene, hexabromobenzene, decabromodiphenyl, decabromodiphenyl ether, bis(tribromophenoxy)ethane, tetrabromophthalic anhydride, ethylene bis(tetrabromophthalimide), ethylene bis(pentabromophenyl), octabromotrimethylphenylindan, and tris(tribromoneopentyl)phosphate; brominated polystyrenes; brominated polybenzyl acrylates; a brominated phenoxy resin; brominated polycarbonate oligomers; tetrabromobisphenol A and tetrabromobisphenol A derivatives such as tetrabromobisphenol A-bis(2,3-dibromopropyl ether), tetrabromobisphenol A- bis(allylether), and tetrabromobisphenol A-bis(hydroxyethyl ether); bromine-containing triazine compounds such as tris(tribromophenoxy)triazine; and bromine-containing isocyanuric acid compounds such as tris(2,3-dibromopropyl)isocyanurate. Of these compounds, it is preferable to use one or more selected from the group consisting of a phosphoric acid ester amide compound, an organic cyclic phosphorus-based compound, and a brominated phenoxy resin flame retardant, from the viewpoint of excellent flame retardance.

Examples of the flame retardant auxiliary include an antimony-based compound and a composite metal including antimony. Examples of the antimony-based compound include antimony trioxide, antimony tetraoxide, antimony pentoxide, sodium antimonate, potassium antimonate, and calcium antimonate. It is more preferable to use one or more selected from the group consisting of antimony trioxide, antimony pentoxide, and sodium antimonate, from the viewpoint of improving the flame retardance and the influence on a touch. For example, it is preferable that the flame retardant auxiliary is contained in an amount of 0.1 parts by weight or more and 10 parts by weight or less with respect to 100 parts by weight of the main component resin, although there is no limitation thereto.

In particular, when the polyamide-based resin composition constituting the sheath part contains the flame retardant auxiliary, appropriate asperities are formed on the surface of the fiber, and a core-sheath conjugate fiber for artificial hair having an appearance with a low gloss close to that of human hair as well as flame retardance is likely to be obtained.

### Method for Producing Core-Sheath Conjugate Fiber

It is possible to produce the core-sheath conjugate fiber for artificial hair by melt-kneading each of a core part resin composition and a sheath part resin composition using various types of ordinary kneaders, and then performing melt spinning using a core-sheath conjugate nozzle. For example, the core part resin composition is prepared by dry blending components such as the above-described polyester-based resin and the brominated epoxy-based flame retardant, and melt-kneading the obtained polyester-based resin composition using any of various ordinary kneaders. On the other hand, the sheath part resin composition is prepared by dry blending components such as the above-described polyamide-based resin and the brominated epoxy-based flame retardant, and melt-kneading the obtained polyamide-based resin composition using any of various ordinary kneaders. The core-sheath conjugate fiber can be produced by melt spinning the core part resin composition and the sheath part resin composition using a conjugate spinning nozzle. The resin compositions may further contain other thermoplastic resins such as a polycarbonate-based resin, as necessary. Examples of the kneaders include a single-screw extruder, a twin-screw extruder, a roll, a Banbury mixer, and a kneader. Of these kneaders, it is preferable to use a twin-screw extruder from the viewpoint of adjusting the kneading degree and easily performing the operation.

For example, in the case of a polyester-based resin composition, melt spinning is performed while the temperatures of an extruder, a gear pump, a nozzle, and the like are set to 250° C. or more and 300° C. or less, and in the case of a polyimide-based resin composition, melt spinning is performed while the temperatures of an extruder, a gear pump, a nozzle, and the like are set to 260° C. or more and 320° C. or less, after which the extruded yarns are allowed to pass through a heated tube, cooled to a temperature not higher than the glass transition points of the resins, and wound up at a speed of 50 m/min or more and 5000 m/min or less, and thus extruded yarns (undrawn yarns) are obtained. Note that during the melt spinning, the core part resin composition can be supplied from a core-part extruder, and the sheath part resin composition can be supplied from a sheath- part extruder.

It is preferable that the extruded yarns (undrawn yarns) are hot drawn. The drawing may be performed by either a two-step method or a direct drawing method. In the two-step method, the extruded yarns are wound once, and then drawn. In the direct drawing method, the extruded yarns are drawn continuously without winding. The hot drawing may be performed by a single-stage drawing method or a multi-stage drawing method that includes two or more stages.

In the melt spinning, the fluctuation cycle of a sheath-side nozzle pressure may be 10 times/min or more and 40 times/min or less. If the fluctuation cycle of the sheath-side nozzle pressure is in the above range, the coefficient of variation of the single fiber diameter is likely to be 10% or more and 40% or less.

The heating means for the hot drawing may be a heating roller, a heat plate, a steam jet apparatus, a hot water bath, or the like, which can be used in combination as desired.

It is also possible to make the touch and texture closer to those of human hair, by adding an oil solution such as a fiber treating agent and a softener to the core-sheath conjugate fiber for artificial hair. Examples of the fiber treating agent include a silicone-based fiber treating agent and a non-silicone-based fiber treating agent for improving the touch and the combing property.

The core-sheath conjugate fiber for artificial hair may be subjected to gear crimping. In this case, it is possible to make the fiber gently curved and have a natural appearance, and to reduce the contact between fibers, thereby improving the combing property. In the gear crimping, typically, a fiber heated to the softening temperature or more is caused to pass through a portion between two meshing gears, so that the shape of the gears is transferred to the fiber, and the fiber is thus curved. Furthermore, as necessary it is also possible to make a fiber curled in different shapes by heat-treating the core-sheath conjugate fiber for artificial hair at different temperatures during the fiber treatment processes.

### Hair Ornament Product

The core-sheath conjugate fiber for artificial hair can be used for hair ornament products without particular limitation. For example, it is possible to use the core-sheath conjugate fiber for hair wigs, hairpieces, weaving hair hair extensions, braided hair, hair accessories, doll hair, and the like.

The hair ornament product may be constituted only by the core-sheath conjugate fiber for artificial hair of one or more embodiments of the present invention. Alternatively, the hair ornament product may be comprised of the core-sheath conjugate fiber for artificial hair of one or more embodiments of the present invention combined with other fibers for artificial hair and natural fibers such as human hair and animal hair

### Examples

Hereinafter, one or more embodiments of the present invention will be more specifically described by way of examples. Note that one or more embodiments of the present invention are not limited to these examples.

The measuring methods and the evaluation methods used in the examples and comparative examples are as follows.

### Single Fiber Fineness

The single fiber fineness was determined by measuring the fineness of 10 samples (single fiber samples) using an autovibro type fineness measuring apparatus “Denier Computer type DC-11” (manufactured by Search), and calculating an average of the measured values.

### Coefficient of Variation

The coefficient of variation was calculated using the expression (1) below based on a total of 100 pieces of fiber diameter data obtained by using randomly selected 10 samples of single fiber and measuring the fiber diameter at 10 points set at intervals of 10 cm in the length direction of each fiber using a fineness measuring apparatus “DC-21 DENICON” (manufactured by Search).

Coefficient of variation (%)=(standard deviation/average value)×100 (1)

### Fluctuation Cycle of Sheath-Side Nozzle Pressure

The number of fluctuation cycles per minute was determined by malting a graph of pressure fluctuation in every 0.1 seconds based on pressure detected using a pressure gauge (Manufactured by Dynisco) installed in an extruder from which the sheath part resin composition was extruded, and taking a period between points of change from a pressure rise to a pressure fall or from a pressure fall to a pressure rise as a ½ cycle.

### Melt Viscosity of Poly-Amide-Based Resin Composition

The melt viscosity was measured using pellets of a polyamide-based resin composition dried to have a moisture content of 1000 ppm or less and a resin viscometer (LCR7000 manufactured by Dynisco). The measurement was performed with the temperature of a cylinder set to a nozzle setting temperature, i.e., 260° C., under conditions of a piston fall speed of 100 mm/min, and a die pore diameter of 1 mm. The sample amount was 20 g.

### Core-to-Sheath Area Ratio

Fibers were bundled at room temperature and fixed with a shrinkage tube such that the fiber bundle (total fineness: 550 dtex) was not displaced, after which the bundle was cut in round slices using a cutter, and thus a fiber bundle for cross section observation was prepared. An image of this fiber bundle was captured using a laser microscope (“VK-9500” manufactured by Keyence Corporation) at a magnification of 500 times, and the core-to-sheath area ratio was evaluated based on the obtained photograph of a fiber cross section.

### Gloss

Sensory evaluation by professional hairstylists was performed in three stages below.
A: Very good gloss similar to that of human hair
B: Good gloss although it is slightly poor compared with that of human hair
C: Bad gloss that is poor compared with that of human hair

### Touch

Sensory evaluation by professional hairstylists was performed in three stages below:
A: Very good touch similar to that of human hair
B: Good touch although it is slightly poor compared with that of human hair
C: Bad touch that is poor compared with that of human hair

### Example 1

30 parts by weight of a brominated epoxy-based flame retardant (product name “SR-T2MP” manufactured by Sakamoto Yakuhin Kogyo Co., Ltd.) and 3 parts by weight of sodium antimonate (product name “SA-A” manufactured by NIHON SEIKO CO., LTD.) were added to 100 parts by weight of polyethylene terephthalate pellets (EastPET product name “A-12” manufactured by East West Chemical Private Limited, hereinafter also referred to as “PET”) dried to have a moisture content of 100 ppm or less, the mixture was dry blended, then supplied to a twin-screw extruder, melt-kneaded at a barrel setting temperature of 280° C., and pelletized, and thus a polyester-based resin composition was obtained. The pellets were dried again to have a moisture content of 100 ppm or less.

Next, 12 parts by weight of a brominated epoxy-based flame retardant (product name “SR-T2MP” manufactured by Sakamoto Yakuhin Kogyo Co., Ltd.) and 2 parts by weight of sodium antimonate (product name “SA-A” manufactured by NIHON SEIKO CO., LTD.) were added to 100 parts by weight of Nylon 6 (product name “A1030BRL” manufactured by UNITIKA LTD., hereinafter also referred to as “PA6”) dried to have a moisture content of 1000 ppm or less, the mixture was dry blended, then supplied to a twin-screw extruder, melt-kneaded at a barrel setting temperature of 260° C., and pelletized, and thus a polyimide-based resin composition was obtained. The pellets were dried again to have a moisture content of 1000 ppm or less.

Next, the polyester-based resin composition and the polyimide-based resin composition in the form of pellets were supplied to extruders, extruded from a concentric core-sheath conjugate spinning nozzle (number of pores: 120, pore diameter: 1.5 min) at a set temperature of 260° C., and wound up at a speed of 40 to 200 m/min, and thus undrawn yarns of core-sheath conjugate fibers each including a core part comprised of the polyester-based resin composition and a sheath part comprised of the polyimide-based resin composition, having a core-to-sheath area ratio of 5:5, and in which the core part and the fiber had circular cross sectional shapes were obtained.

The obtained undrawn yarns were drawn to 3 times while being wound up at a speed of 45 m/min using a heat roll at 85° C., and subsequently heat-treated by being wound up at a speed of 45 m/min using a heat roll heated to 200° C. After application of a polyether-based oil solution (product name “KWC-Q” manufactured by Marubishi Oil Chemical Corporation) in an amount of 0.20% omf (by oil pure weight percentage with respect to the dry fiber weight), the yarns were dried, and thus a core-sheath conjugate fiber having a single fiber fineness of 80 dtex was obtained.

### Example 2

A conjugate fiber was obtained in a similar way to that of Example 1, except that the single fiber fineness was changed to 50 dtex by adjusting the discharge amount.

### Example 3

A conjugate fiber was obtained in a similar way to that of Example 1, except that the single fiber fineness was changed to 30 dtex by adjusting the discharge amount.

### Example 4

A conjugate fiber was obtained in a similar way to that of Example 1, except that the single fiber fineness was changed to 20 dtex by adjusting the discharge amount.

### Example 5

A conjugate fiber was obtained in a similar way to that of Example 2, except that the core-to-sheath area ratio was changed to 8:2.

### Example 6

A conjugate fiber was obtained in a similar way to that of Example 2, except that the core-to-sheath area ratio was changed to 2:8.

### Example 7

A conjugate fiber was obtained in a similar way to that of Example 2, except that the temperature of the extruder for the sheath part resin composition was changed such that the polyamide-based resin composition had a melt viscosity of 250 Pa·s at the nozzle setting temperature (260° C.).

### Example 8

A conjugate fiber was obtained. in a similar way to that of Example 2, except that the temperature of the extruder for the sheath part resin composition was changed such that the polyamide-based resin composition had a melt viscosity of 200 Pa·s at the nozzle setting temperature (260° C.).

### Comparative Example 1

A conjugate fiber was obtained in a similar way to that of Example 1, except that the single fiber fineness was changed to 90 dtex by adjusting the discharge amount.

### Comparative Example 2

A conjugate fiber was obtained in a similar way to that of Example 1, except that the single fiber fineness was changed to 15 dtex by adjusting the discharge amount.

### Comparative Example 3

A conjugate fiber was obtained in a similar way to that of Example 2, except that the core-to-sheath area ratio was changed to 9:1.

### Comparative Example 4

A conjugate fiber was obtained in a similar way to that of Example 2, except that the core-to-sheath area ratio was changed to 1:9.

### Comparative Example 5

A conjugate fiber was obtained in a similar way to that of Example 2, except that the temperature of the extruder for the sheath part resin composition was changed such that the polyamide-based resin composition had a melt viscosity of 280 Pa·s at the nozzle setting temperature (260° C.).

### Comparative Example 6

A conjugate fiber was obtained in a similar way to that of Example 2, except that the temperature of the extruder for the sheath part resin composition was changed such that the polyamide-based resin composition had a melt viscosity of 180 Pa·s at the nozzle setting temperature (260° C.).

In the examples and the comparative examples, the fluctuation cycle of the sheath-side nozzle pressure was determined as described above. Also, with respect to the fibers of the examples and the comparative examples, the coefficient of variation of the single fiber diameter, the touch, and gloss were evaluated as described above. The results are shown in Table 1.

TABLE 1

| | | | | | Fluctuation | Melt | | | |
|---|---|---|---|---|---|---|---|---|---|
| | | Main | | CV value | cycle of | viscosity of | Core- | | |
| | | component | Single | of single | sheath-side | sheath part | to- | | |
| | | resin (core | fiber | fiber | nozzle | resin | sheath | | |
| | | part/sheath | fineness | diameter | pressure | composition | area | | |
| | | part) | dtex | % | times/min | Pa · s | ratio | Gloss | Touch |
| Ex. | 1 | PET/PAG | 80 | 10 | 40 | 230 | 5:5 | B | B |
| | 2 | PET/PA6 | 50 | 25 | 25 | 230 | 5:5 | A | A |
| | 3 | PET/PAG | 30 | 35 | 16 | 230 | 5:5 | A | A |
| | 4 | PET/PAG | 20 | 40 | 10 | 230 | 5:5 | A | B |
| | 5 | PET/PAG | 50 | 35 | 20 | 230 | 8:2 | A | A |
| | 6 | PET/PA6 | 50 | 30 | 35 | 230 | 2:8 | A | B |
| | 7 | PET/PA6 | 50 | 40 | 10 | 250 | 5:5 | A | B |
| | 8 | PET/PAG | 50 | 15 | 40 | 200 | 5:5 | A | B |
| Com. | 1 | PET/PAG | 90 | 5 | 55 | 230 | 5:5 | C | C |
| Ex. | 2 | PET/PAG | 15 | 50 | 10 | 230 | 5:5 | B | C |
| | 3 | PET/PAG | 50 | 55 | 5 | 230 | 9:1 | C | C |
| | 4 | PET/PAG | 50 | 45 | 50 | 230 | 1:9 | C | B |
| | 5 | PET/PAG | 50 | 50 | 5 | 280 | 5:5 | B | C |
| | 6 | PET/PAG | 50 | 5 | 30 | 180 | 5:5 | C | C |

As can be seen from Table 1, in the cases of the fibers of Examples 1 to 8, the single fiber fineness was 20 dtex or more and 80 dtex or less, the CV value of the single fiber diameter was 10% or more and 40% or less, and the fibers had a gloss and a touch close to those of human hair.

On the other hand, when the single fiber fineness or the coefficient of variation was outside the above ranges as in Comparative Examples 1 to 6, the touch and/or gloss was significantly impaired.

One or more embodiments of the present invention may include, for example, the following embodiments, although there is no particular limitation thereto.

[1] A core-sheath conjugate fiber for artificial hair including a core part and a sheath part,
wherein the core part is comprised of a polyester-based resin composition that contains a polyester-based resin, and the sheath part is comprised of a polyamide-based resin composition that contains a polyamide-based resin, and
the core-sheath conjugate fiber for artificial hair has a single fiber fineness of 20 dtex or more and 80 dtex or less and a coefficient of variation of the single fiber diameter of 10% or more and 40% or less.

[2] The core-sheath conjugate fiber for artificial hair according to [1], wherein the core-sheath conjugate fiber for artificial hair has a core-to-sheath area ratio of core:sheath=2:8 to 8:2.

[3] The core-sheath conjugate fiber for artificial hair according to [1] or [2], wherein the sheath part has a melt viscosity in the range of 200 Pa·s or more and 250 Pa·s or less at 260° C.

[4] The core-sheath conjugate fiber for artificial hair according to any one of [1] to [3], wherein the polyester-based resin composition contains one or more of polyester-based resins selected from the group consisting of polyalkylene terephthalate and a copolymerized polyester mainly containing polyalkylene terephthalate.

[5] The core-sheath conjugate fiber for artificial hair according to any one of [1] to [4], wherein the polyamide-based resin composition contains a polyamide-based resin mainly containing at least one selected from the group consisting of Nylon 6 and Nylon 66.

[6] A hair ornament product including the core-sheath conjugate fiber for artificial hair according to any one of [1] to [5].

[7] The hair ornament product according to [6], wherein the hair ornament product is one selected from the group consisting of a hair wig, a hairpiece, weaving hair, a hair extension, braided hair, a hair accessory, and doll hair.

[8] A method for producing the core-sheath conjugate fiber for artificial hair according to any one of [1] to [5], including
a step of melt spinning the polyester-based resin composition and the poly amide-based resin composition using a core-sheath conjugate nozzle,
wherein the polyamide-based resin composition has a melt viscosity in the range of 200 Pa·s or more and 250 Pa·s or less at a set temperature of the core-sheath conjugate nozzle.

[9] The method for producing the core-sheath conjugate fiber for artificial hair according to [8], wherein a fluctuation cycle of a sheath-side nozzle pressure is 10 tames/min or more and 40 times/min or less.

### LIST OF REFERENCE NUMERALS

1 Core-sheath conjugate fiber for artificial hair (cross section)

10 Sheath part

20 Core part

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A core-sheath conjugate fiber for artificial hair comprising:
a core part; and
a sheath part,
wherein:
the core part is comprised of a polyester-based resin composition that comprises a polyester-based resin,
the sheath part is comprised of a polyamide-based resin composition that comprises a polyamide-based resin, and
the core-sheath conjugate fiber for artificial hair has a single fiber fineness of 20 dtex or more and 80 dtex or less and a coefficient of variation of a single fiber diameter of 10% or more and 40% or less.

2. The core-sheath conjugate fiber for artificial hair according to claim 1, wherein the core- sheath conjugate fiber for artificial hair has a core-to-sheath area ratio of core:sheath=2:8 to 8:2.

3. The core-sheath conjugate fiber for artificial hair according to claim 1, wherein the sheath part has a melt viscosity in a range of 200 Pa·s or more and 250 Pa·s or less at 260° C.

4. The core-sheath conjugate fiber for artificial hair according to claim 1, wherein the polyester-based resin composition comprises one or more of polyester-based resins selected from the group consisting of polyalkylene terephthalate and a copolymerized polyester mainly containing polyalkylene terephthalate.

5. The core-sheath conjugate fiber for artificial hair according to claim 1, wherein the polyamide-based resin mainly contains at least one selected from the group consisting of Nylon 6 and Nylon 66.

6. The core-sheath conjugate fiber for artificial hair according to claim 1, wherein the core-sheath conjugate fiber is a melt spinning fiber.

7. A hair ornament product comprising the core-sheath conjugate fiber for artificial hair according to claim 1.

8. The hair ornament product according to claim 7, wherein the hair ornament product is one selected from the group consisting of a hair wig, a hairpiece, weaving hair, a hair extension, braided hair, a hair accessory, and doll hair.

9. The hair ornament product according to claim 7, wherein the core-sheath conjugate fiber for artificial hair has a core-to-sheath area ratio of core:sheath=2:8 to 8:2.

10. The hair ornament product according to claim 7, wherein the sheath part of the core-sheath conjugate fiber has a melt viscosity in a range of 200 Pa·s or more and 250 Pa·s or less at 260° C.

11. The hair ornament product according to claim 7, wherein the polyester-based resin composition comprises one or more of polyester-based resins selected from the group consisting of polyalkylene terephthalate and a copolymerized polyester mainly containing polyalkylene terephthalate.

12. The hair ornament product according to claim 7, wherein the poly-amide-based resin mainly contains at least one selected from the group consisting of Nylon 6 and Nylon 66.

13. The hair ornament product according to claim 7, wherein the core-sheath conjugate fiber is a melt spinning fiber.

14. A method for producing the core-sheath conjugate fiber for artificial hair according to claim 1, comprising a step of melt spinning the polyester-based resin composition and the polyimide-based resin composition with a core-sheath conjugate nozzle, wherein:
the polyamide-based resin composition has a melt viscosity in a range of 200 Pa·s or more and 250 Pa·s or less at a set temperature of the core-sheath conjugate nozzle, and
a fluctuation cycle of a sheath-side nozzle pressure is 10 limes/min or more and 40 times/min or less.

15. The method for producing the core-sheath conjugate fiber for artificial hair according to claim 14, wherein the core-sheath conjugate fiber for artificial hair has a core-to-sheath area ratio of core:sheath=2:8 to 8:2.

16. The method for producing the core-sheath conjugate fiber for artificial hair according to claim 14, wherein the polyester-based resin composition comprises one or more of polyester-based resins selected from the group consisting of polyalkylene terephthalate and a copolymerized polyester mainly containing polyalkylene terephthalate.

17. The method for producing the core-sheath conjugate fiber for artificial hair according to claim 14, wherein the poly-amide-based resin mainly contains at least one selected from the group consisting of Nylon 6 and Nylon 66.
